(19) United States
(12) Patent Application Publication
(10) Pub. No.: US 2019/0271994 A1
(43) Pub. Date: Sep. 5, 2019

(54) MOVABLE SUPPORT FRAME THERMOSTAT

(71) Applicant: M.A.P. MOTORAD AUTOMOTIVE PARTS LTD, Misgav (IL)

(72) Inventor: Aviram ARBEL, Hod Hasharon (IL)

(21) Appl. No.: 16/348,267

(22) PCT Filed: Nov. 1, 2017
(86) PCT No.: PCT/IL2017/051191

§ 371 Date: May 8, 2019

Related U.S. Application Data
(60) Provisional application No. 62/421,298, filed on Nov. 13, 2016.

(51) Int. Cl. G05D 23/02; F01P 7/16

(52) U.S. Cl. CPC G05D 23/022; G05D 23/1925; F01P 7/16

(57) ABSTRACT

The present disclosure provides thermostats and thermostat housings with a support frame that is linearly displaceable relative to an aperture of the thermostat, for modifying operational characteristics of the opening and closing of the aperture by a valve actuated via a thermal-actuator with an extendible pin configured to be pressed against the support frame for moving the valve to open and close the aperture.

### FIELD

The present disclosure generally relates to the field of thermostats.

### BACKGROUND

The control over the temperature of mechanical parts, such as internal combustion engines, determines several characteristics related to the operation thereof, for example, the fuel burning efficiency, pollutant generation, power generation, and the like.

Commonly, the temperature of engines is controlled using thermostats that facilitate controlled flow of coolant fluids between the engine and the radiator, and these thermostats are thermally actuated such that when the temperature of a thermal-sensitive element thereon reaches a certain threshold, a pin is extended to push against a support structure and affect opening of an aperture allowing for coolant fluid flow. Generally, the operation characteristics of the thermostats are static, in that once they are installed they are not controlled, and the temperatures of operation are predetermined. Additionally, common thermostats are affected by the temperature of the fluids provided from the engine, and cannot be controlled based on other parameters.

There is thus a need in the art for a thermostat with a controllable operation of valve opening and closing, and adjustable thermal-actuation characteristics.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

Common thermostats include an aperture and a valve member configured to be pressed against the aperture for obstructing flow of fluids therethrough, and separated/distanced from the aperture for permitting flow of fluids therethrough. The valve is integrated with a thermosensitive actuator configured to extend a pin based on the temperature thereof (or a contained heat sensitive material such as wax). When the pin is extended, it is pressed against a support frame, and pushes the thermosensitive actuator and valve apart from the aperture. When the temperature of the thermosensitive actuator is lowered, the pin retracts back, resulting in placing the valve against the aperture for closing it and obstructing the fluid flow therethrough.

The opening and closing of the aperture is dictated by the properties of the thermostatic actuator, the dimensions of the pin, and the distance between the support frame and the aperture. The further the distance between the support frame and the aperture is, the further extended out the pin needs to be for affecting a distancing of the valve and opening of the valve. On the other hand, the closer the distance between the support frame and the aperture is, the slighter the extension of the pin is needed for affecting a distancing/separation of the valve and opening of the valve.

Normally, the support frame is stationary and affixed/integrated with the body of the thermostat, and the distance between the support frame and the aperture is therefore constant.

According to some embodiments, there are provided herein thermostat devices and systems wherein the support frame (upper support frame) is controllably movable/displaceable linearly to be placed at a desired distance from the aperture, thereby modifying the actuation temperature of the thermostat by altering the pin extension needed for pushing the valve away from the aperture.

According to some embodiments, the support frame is controllably movable/displaceable towards the aperture for affecting a forced opening of the valve by pushing against the pin and associated thermosensitive actuator and valve, thereby separating/distancing them from the aperture, regardless of the thermally-actuated extension of the pin.

According to some embodiments, there is provided herein a thermostat, configured for controlling a flow of fluid, comprising: a source chamber, configured to contain coolant fluids provided from a radiator; a drain chamber, configured to contain coolant fluids to be provided to an engine; a valve, movable for affecting opening and closing of an aperture between the source chamber and the drain chamber, thereby facilitating and blocking a flow of fluid from the source chamber to the drain chamber; a thermal-actuator, mechanically connected to the valve, including a reversibly extendible pin with a distal end at the extremis thereof, configured to be extended and retracted based on temperature of the thermal-actuator; a linearly displaceable support-frame, located adjacent to the distal end of the pin, and configured to provide a mechanical contra to the extension of the pin, such that, upon extension of the pin, the thermal-actuator and valve are pushed/distanced/parted from the aperture, facilitating a flow of fluid from the source chamber to the drain chamber; and a hydraulic actuation chamber with a hydraulic-port, configured to be connected to a hydraulic pump to be provided with pressurized fluids via the hydraulic-port, for actuating a linear displacement of the support frame relative to the aperture for modifying operational characteristics of the opening and closing of the aperture by the valve.

According to some embodiments, the thermostat may further include a diaphragm, connected between the support-frame and inner surface/walls of the source chamber, configured to provide a sealed separation between the hydraulic actuation chamber and the source chamber.

According to some embodiments, the support-frame is linearly displaceable within a range of 0.1 mm to 15 mm (for example, 0.1 mm-1 mm, 0.5 mm-2 mm, 5mm-10 mm etc.) from a default position.

According to some embodiments, the thermostat further includes a hydraulic valve, configured to controllably open and close the hydraulic port. The hydraulic valve may include a solenoid valve operator.

According to some embodiments, the support-frame is linearly displaceable relative to the aperture for pressing against the pin and affecting a movement of the pin, the thermal-actuator and the valve apart from the valve, thereby facilitating a forced opening of the aperture. According to some embodiments, the support-frame is linearly displaceable relative to the aperture to control/regulate the amount of extension of the pin required for affecting an opening of the valve. According to some embodiments, the support-frame is linearly displaceable between at least a baseline-position and a high-position, such that in the baseline position the support frame is approximated to the aperture for providing mechanical contra to the extension of the pin from an early stage thereof, and in the high-position the support frame is distanced from the aperture for providing mechanical contra to the extension of the pin from a later stage thereof.

According to some embodiments, there is provided herein a thermostat housing, configured for controlling a flow of fluid, comprising: a source chamber, configured to contain coolant fluids provided from a radiator; a radiator-inlet orifice, configured to be fluidly connected with a radiator and provide coolant fluids from the radiator to the source chamber; a drain chamber, configured to contain coolant fluids to be provided to an engine; an engine-inlet orifice, configured to be fluidly connected with an engine and provide coolant fluids from the engine to the drain chamber; an engine-outlet orifice, configured to be fluidly connected with the engine and provide coolant fluids from the drain chamber to the engine; a valve, movable for affecting opening and closing of an aperture between the source chamber and the drain chamber, thereby facilitating and blocking a flow of fluid from the source chamber to the drain chamber; a thermal-actuator, mechanically connected with the valve, including a reversibly extendible pin with a distal end at the extremis thereof, configured to be extended and retracted based on temperature of the thermal-actuator; a linearly displaceable support-frame, located adjacent to the distal end of the pin, and configured to provide a mechanical contra to the extension of the pin, such that, upon extension of the pin, the thermal-actuator and valve are pushed/distanced/parted from the aperture, facilitating a flow of fluid from the source chamber to the drain chamber; and a hydraulic actuation chamber with a hydraulic-port, configured to be connected to a hydraulic pump to be provided with pressurized fluids via the hydraulic-port, for actuating a linear displacement of the support frame relative to the aperture for modifying operational characteristics of the opening and closing of the aperture by the valve.

According to some embodiments, the thermostat housing further includes a diaphragm, connected between the support-frame and inner surface/walls of the source chamber, configured to provide a sealed separation between the hydraulic actuation chamber and the source chamber.

According to some embodiments, the support-frame is linearly displaceable within a range of 0.1 mm to 15 mm (for example, 0.1 mm-1 mm, 0.5 mm-2 mm, 5 mm-10 mm etc.) from a default position.

According to some embodiments, the thermostat housing further includes a hydraulic valve, configured to controllably open and close the hydraulic port. The hydraulic valve may include a solenoid valve operator.

According to some embodiments, the thermostat housing further includes a hydraulic channel, fluidly connected to the hydraulic valve and configured to be connected to a hydraulic pump, for providing pressurized fluids to the hydraulic valve, wherein the hydraulic valve is configured to controllably allow or block the flow of pressurized fluids between the hydraulic actuation chamber and the hydraulic channel via the hydraulic port.

According to some embodiments, the support-frame is linearly displaceable relative to the aperture for pressing against the pin and affecting a movement of the pin, the thermal-actuator and the valve apart from the valve, thereby facilitating a forced opening of the aperture. According to some embodiments, the support-frame is linearly displaceable relative to the aperture to control/regulate the amount of extension of the pin required for affecting an opening of the valve. According to some embodiments, the support-frame is linearly displaceable between at least a baseline-position and a high-position, such that in the baseline position the support frame is approximated to the aperture for providing mechanical contra to the extension of the pin from an early stage thereof, and in the high-position the support frame is distanced from the aperture for providing mechanical contra to the extension of the pin from a later stage thereof.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some, or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 schematically illustrates a common thermostat device;

FIG. 2a schematically illustrates a common thermostat at a closed position;

FIG. 2b schematically illustrates a common thermostat at an open position;

FIG. 3a schematically illustrates a thermostat with a displaceable support-frame in a closed position, with the support-frame placed at a default/initial position, according to some embodiments;

FIG. 3b schematically illustrates a thermostat with a displaceable support-frame in an open position, with the support-frame placed at a default/initial position, according to some embodiments;

FIG. 3c schematically illustrates a thermostat with a displaceable support-frame in a closed position, with the support-frame placed at a raised position and the pin being retracted, according to some embodiments;

FIG. 3d schematically illustrates a thermostat with a displaceable support-frame in a closed position, with the support-frame placed at a raised position and the pin being partially extended, according to some embodiments;

FIG. 3e schematically illustrates a thermostat with a displaceable support-frame in an open position, with the support-frame placed at a raised position and the pin being fully extended, according to some embodiments;

FIG. 3f schematically illustrates a thermostat with a displaceable support-frame in an open position, with the support-frame placed at a lowered/dropped position, according to some embodiments;

FIG. 4a schematically illustrates a thermostat with a displaceable support-frame at a default/initial position and a linear frame actuator, according to some embodiments;

FIG. 4b schematically illustrates a thermostat with a displaceable support-frame at a raised position and a linear frame actuator, according to some embodiments;

FIG. 4c schematically illustrates a thermostat with a displaceable support-frame at a lowered/dropped position and a linear frame actuator, according to some embodiments;

FIG. 5 schematically illustrates a thermostat with a displaceable support-frame at a default/initial position and a hydraulic actuator, according to some embodiments;

FIG. 6a schematically illustrates a thermostat with a displaceable support-frame head at a default/initial position and a linear frame actuator, according to some embodiments;

FIG. 6b schematically illustrates a thermostat with a displaceable support-frame head at a raised position and a linear frame actuator, according to some embodiments;

FIG. 6c schematically illustrates a thermostat with a displaceable support-frame head at a lowered/dropped position and a linear frame actuator, according to some embodiments;

FIG. 7a schematically illustrates a thermostat temperature response graph, with a displaceable support frame at a default position, according to some embodiments;

FIG. 7b schematically illustrates a thermostat temperature response graph, with a displaceable support frame at a raised position, according to some embodiments;

FIG. 7c schematically illustrates a thermostat temperature response graph, with a displaceable support frame at a partially lowered position, according to some embodiments;

FIG. 7d schematically illustrates a thermostat temperature response graph, with a displaceable support frame at a fully lowered position, according to some embodiments;

FIG. 8 schematically illustrates a cross section thermostat assembly at a perspective front view, according to some embodiments, and

FIG. 9 schematically illustrates a cross section thermostat assembly at a front view, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Engines, specifically internal combustion engines, are configured to operate at a certain operational temperature, or temperature range, for controlling the properties of the engine operation, such as fuel consumption, power output, torque output, and pollutant exhaustion. For regulating the temperature of engines, a coolant fluid is introduced to the body (block) of the engine for absorbing the generated heat.

When the engine temperature is below the predetermined threshold, or range, the coolant fluid of the engine is circulated without introducing coolant fluids from the radiator. When the engine temperature reaches the predetermined temperature, coolant fluids from the radiator are introduced to the flow cycle for lowering the temperature of the engine back to the desired range or value.

This temperature regulation process is generally carried out using a thermostat, with a thermally actuated valve that opens an aperture for introducing coolant fluids from the radiator to the engine when the sensed temperature reaches a predetermined value.

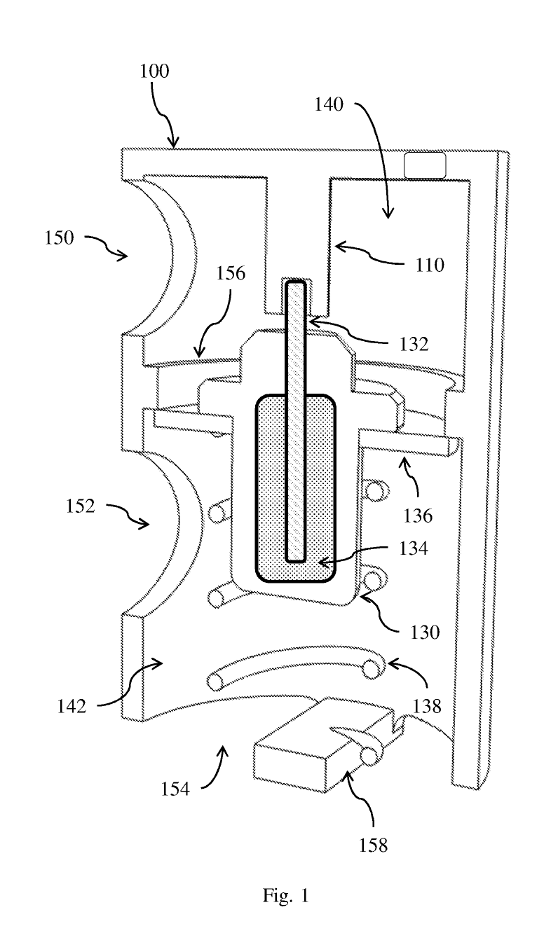

Reference is now made to FIG. 1, which schematically illustrates a common thermostat 100 device. Thermostat 100 includes an engine-inlet orifice 154 configured to provide coolant fluids from the engine, an engine-outlet orifice 152 for providing coolant fluids from thermostat 100 to the engine, and a radiator-inlet orifice 150, configured to provide coolant fluids from a radiator to thermostat 100. Thermostat 100 further includes an internal aperture 156, defining a source chamber 140 which is configured to contain fluids from the radiator provided via radiator-inlet orifice 150, and a drain chamber 142, configured to contain fluids to be provided to the engine via engine-outlet orifice 152. Aperture 156 is opened and closed, to facilitate or obstruct flow of fluids therethrough respectively, by a valve 136, which is movable between a closed position, in which valve 136 is introduced and pressed against aperture 156, and an open position, in which valve 136 is furthered from aperture 156.

When aperture 156 is closed, flow of fluids from source chamber 140 and drain chamber 142 is obstructed, and the coolant fluids of the engine that are introduced via engine-inlet orifice 154 are circulated back to the engine through engine-outlet orifice 152. Alternatively, when aperture 156 is open, flow of fluids from source chamber 140 and drain chamber 142 is facilitated, and the coolant fluids that are provided to the engine through engine-outlet orifice 152 contain a mixture of fluids coming from the radiator via radiator-inlet orifice 150, and fluids coming from the engine via engine inlet orifice 154.

The movement of valve 136 is controlled by a thermal-actuator 130 having a reversibly extendible pin 132 partially immersed in a thermo-expandable material, such as wax 134. The thermal-actuator is at least partially placed in drain chamber 142, and is introduced to fluids from the engine, indicative of the engine temperature.

In operation, when the temperature at the drain chamber is below a certain threshold, wax 134 is contracted, and pin 132 is not pushed to extend outwardly. In this state, valve 136 and thermal-actuator 130 are pushed towards aperture 156 for closing it, for example, by a spring 138 which pushes against valve 136 at one end, and a lower support, such as lower-bridge 158.

When the temperature at the drain chamber reaches a predetermined threshold, wax 134 is expanded, and pin 132 is pushed out of wax 134 to extend upwardly, and a support frame 110 provides a mechanical contra to the extension of pin 132, resulting in pushing thermal-actuator 130 and valve 136 downwardly and affecting an opening of aperture 156.

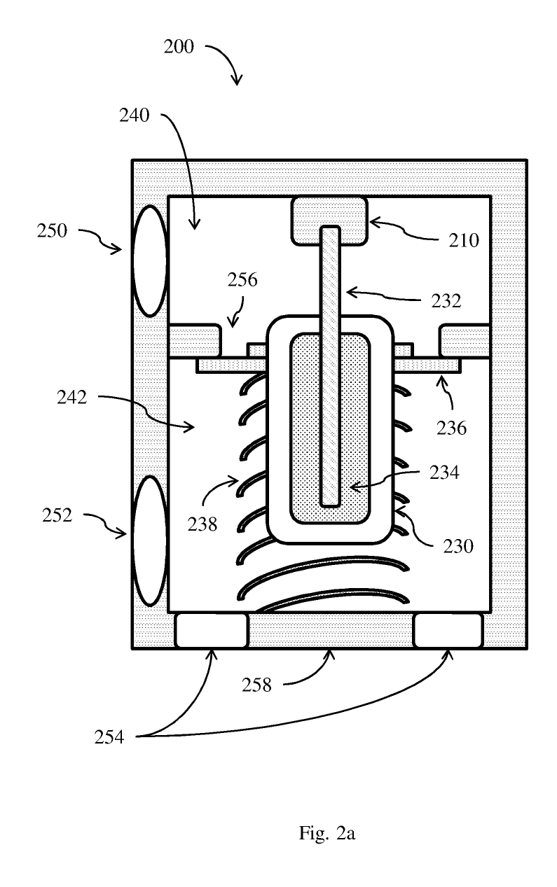

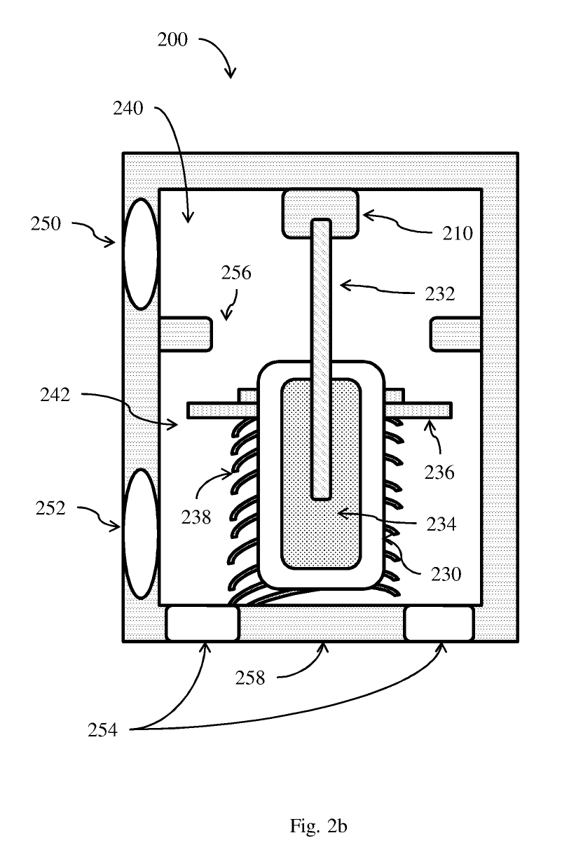

Reference is now made to FIG. 2a, which schematically illustrates a common thermostat 200, essentially similar to thermostat 100 of FIG. 1, at a closed position. Thermostat 200 includes an engine-inlet orifice 254 configured to provide coolant fluids from the engine, an engine-outlet orifice 252 for providing coolant fluids from thermostat 200 to the engine, and a radiator-inlet orifice 250, configured to provide coolant fluids from a radiator to thermostat 200. Thermostat 200 further includes an internal aperture 256, defining a source chamber 240, which is configured to contain fluids from the radiator provided via radiator-inlet orifice 250, and a drain chamber 242, configured to contain fluids to be provided to the engine via engine-outlet orifice 252. Aperture 256 is opened and closed, to facilitate or obstruct flow of fluids therethrough respectively, by a valve 236 which is movable, by a thermal-actuator 230 mechanically connected thereto, between a closed position in which valve 236 is introduced and pressed against aperture 256, and an open position in which valve 236 is furthered from aperture 256.

As illustrated, the temperature at drain chamber 242 is below the predetermined threshold, such that the wax 234 within thermo-actuator 230 is contracted, and pin 232 is not pushed against support frame 210, and spring 238 presses valve 236 to close aperture 256 with support provided by lower bridge 258, and obstructs the flow of fluids from source chamber 240 to drain chamber 242.

Reference is now made to FIG. 2b, which schematically illustrates a common thermostat 200, essentially as disclosed in FIG. 2a, at an open position. When the temperature at drain chamber 242 reached the predetermined threshold, wax 234 is expanded and pushes pin 232 outwardly, then support frame 210 provides mechanical contra to the extension of pin 232, pushing thermal-actuator 230 and valve 236 downwardly, affecting an opening of aperture 256, to facilitate flow of fluids from source chamber 240 to drain chamber 242.

The operation of the common thermostats is calibrated and adjusted at the time of manufacturing of the thermostat, and it relies predominantly on the temperatures of the provided coolant fluids, the expansion of the wax, and the dimensions of the thermal-actuator and pin, resulting in a constant and unchanged temperature response of the valve.

Normally, the support frame is stationary and affixed/integrated with the body of the thermostat, and the distance between the support frame and the aperture is therefore constant, thus the correlation between the pin extension and valve displacement is constant and predetermined.

According to some embodiments, there are provided herein thermostat devices and systems wherein the support frame (upper support frame/upper bridge) is controllably movable/displaceable linearly to be placed at a desired distance from the aperture, thereby modifying/adapting the actuation temperature of the thermostat by altering the pin extension needed for pushing the valve apart from the aperture.

According to some embodiments, the position of the support frame relative to the aperture is adjusted to modify the correlation between the extension of the pin and the opening of the aperture.

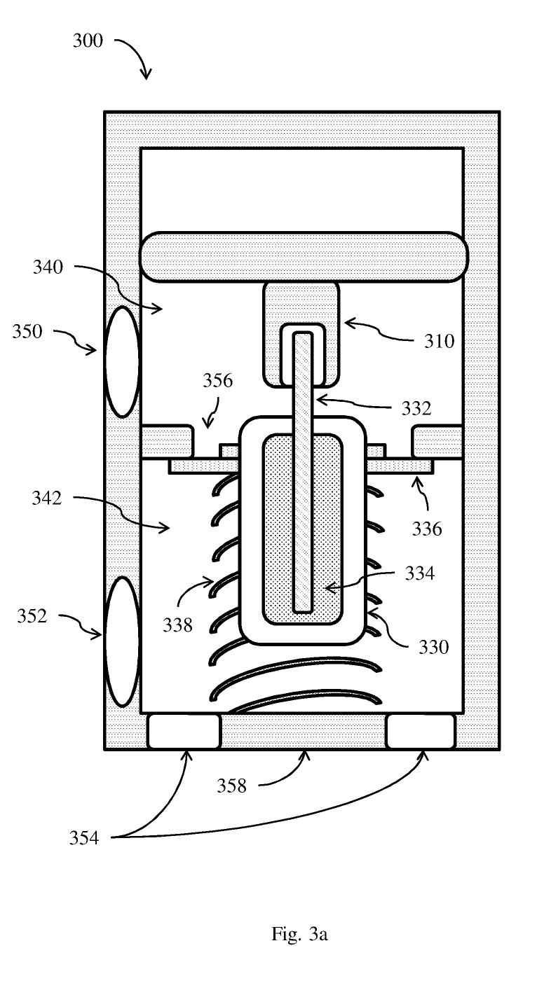

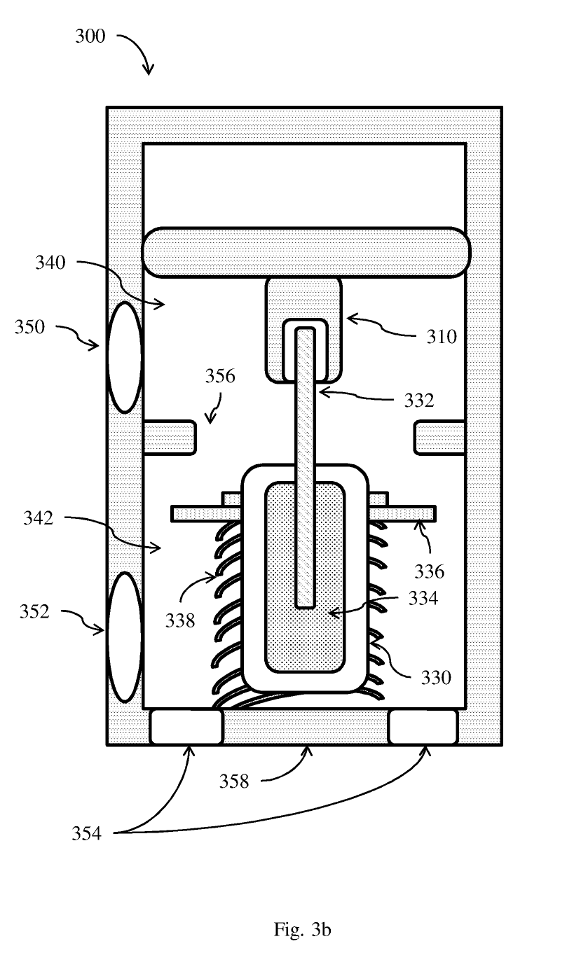

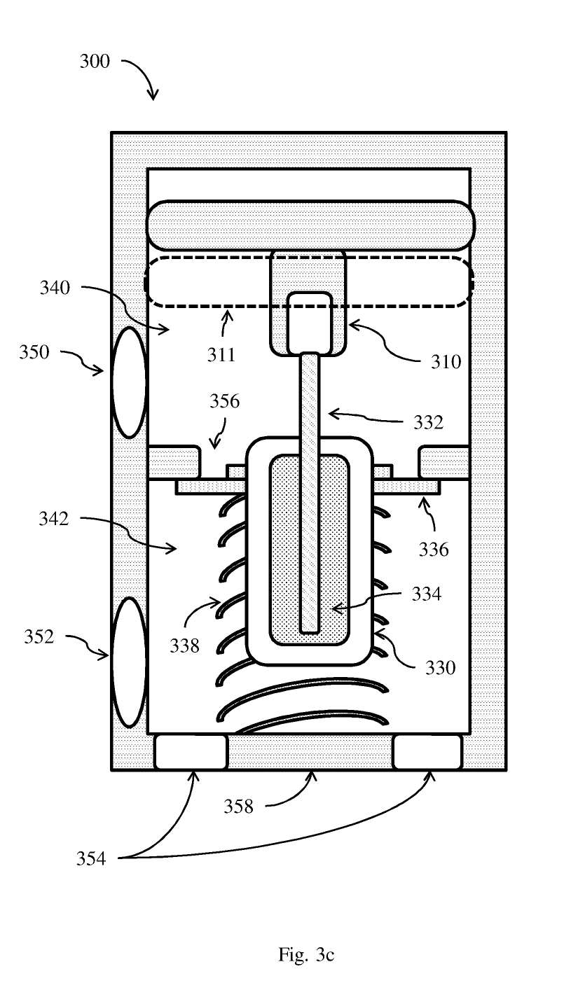

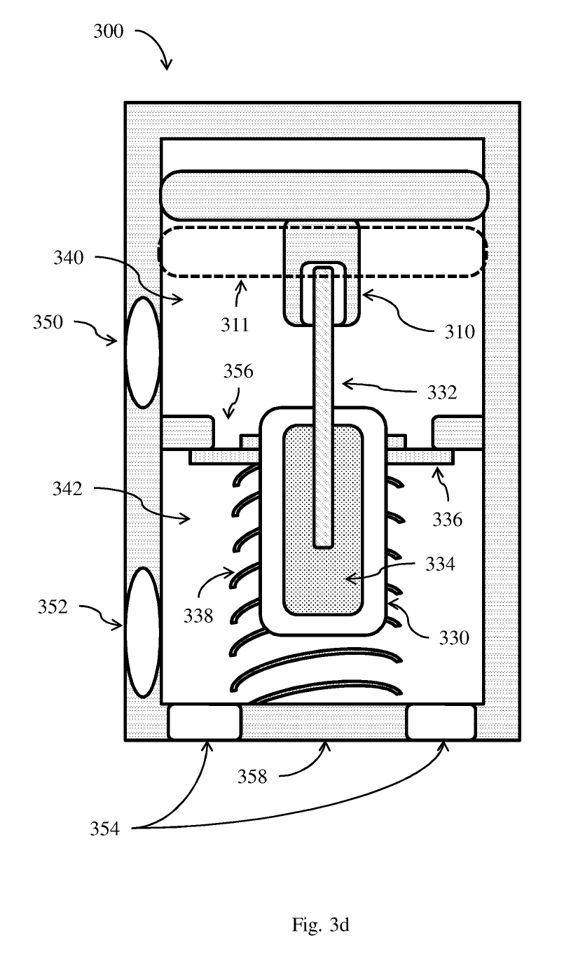

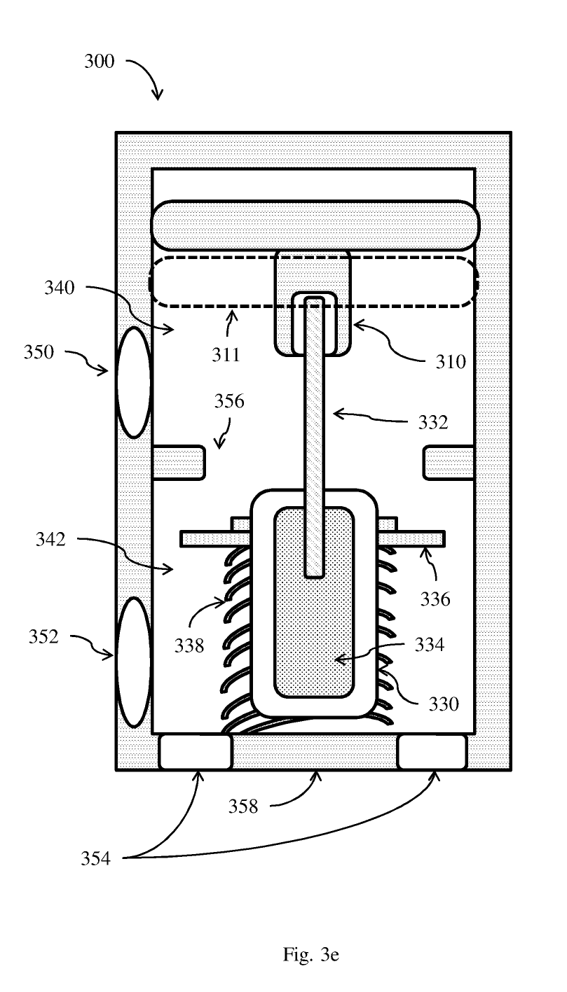

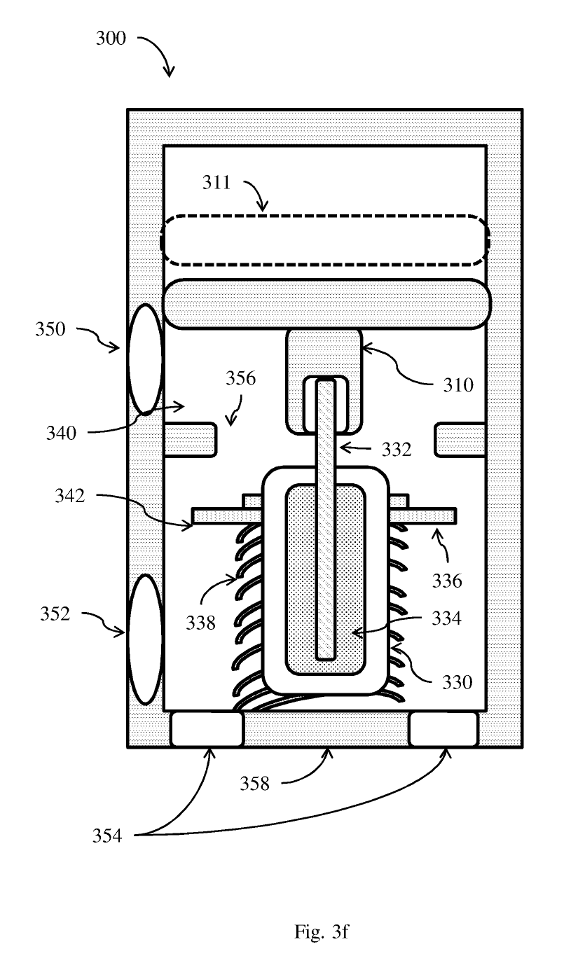

Reference is now made to FIG. 3a, which schematically illustrates a thermostat 300 with a displaceable support-frame 310 and a closed aperture 356, and the support-frame placed at a default/initial position, according to some embodiments. When support frame 310 is placed at a default/initial position, thermostat 300 functions as a regular/common thermostat, essentially as disclosed in FIG. 1, such that thermostat 300 includes an engine-inlet orifice 354 configured to provide coolant fluids from the engine, an engine-outlet orifice 352 for providing coolant fluids from thermostat 300 to the engine, and a radiator-inlet orifice 350, configured to provide coolant fluids from a radiator to thermostat 300. Thermostat 300 further includes internal aperture 356, defining a source chamber 340 which is configured to contain fluids from the radiator provided via radiator-inlet orifice 350, and a drain chamber 342, configured to contain fluids to be provided to the engine via engine-outlet orifice 352. Aperture 356 is opened and closed, to facilitate or obstruct flow of fluids therethrough respectively, by a valve 336 which is movable between a closed position in which valve 336 is introduced and pressed against aperture 356, and an open position in which valve 336 is distanced away from aperture 356.

When aperture 356 is closed, flow of fluids from source chamber 340 and drain chamber 342 is obstructed, and the coolant fluids of the engine that are introduced via engine-inlet orifice 354 are circulated back to the engine through engine-outlet orifice 352. Alternatively, when aperture 356 is open, flow of fluids from source chamber 340 and drain chamber 342 is facilitated, and the coolant fluids that are provided to the engine through engine-outlet orifice 352 contain a mixture of fluids coming from the radiator via radiator-inlet orifice 350, and fluids coming from the engine via engine inlet orifice 354.

The movement of valve 336 is controlled by a thermal-actuator 330 having a reversibly extendible pin 332 partially immersed in a thermo-expandable material, such as wax 334. The thermal-actuator is at least partially placed in drain chamber 342, and is introduced to fluids from the engine, indicative of the engine temperature.

In operation, when the temperature at the drain chamber is below a certain threshold, wax 334 is contracted, and pin 332 is not pushed to extend outwardly. In this state, valve 336 and thermal-actuator 330 are pushed towards aperture 356 thereby closing it, for example, by a spring 338 which pushes against valve 336 at one end, and a lower support, such as lower-bridge 358.

When the temperature at the drain chamber reaches a predetermined threshold, wax 334 is expanded, and pin 332 is pushed out of wax 334 to extend upwardly, and support frame 310 provides a mechanical contra to the extension of pin 332, resulting in pushing thermal-actuator 330 and valve 336 downwardly and affecting an opening of aperture 356.

In FIG. 3a, wax 334 is contracted, not pushing pin 332 outwardly, and valve 336 is pushed against aperture 356, closing it and obstructing the flow of fluids therethrough from source chamber 340 to drain chamber 342.

Reference is now made to FIG. 3b, which schematically illustrates a thermostat 300, essentially as disclosed in FIG. 3a, with a displaceable support-frame 310 and an open aperture 356, and support-frame 310 placed at a default/initial position, according to some embodiments. As depicted in FIG. 3b, temperature at drain chamber 342 is above the predetermined threshold, expanding wax 334 and extending pin 332 to be pressed against support frame 310 to push thermal-actuator 330 and valve 336 downwardly, affecting an opening of aperture 356, and facilitating a flow of coolant fluids from source chamber 340 to drain chamber 342.

Advantageously, support frame 310 is linearly displaceable, such that the correlation between the extent/degree/amount of pin 332 extension and movement of valve 336 affecting opening of aperture 356 is modifiable.

Reference is now made to FIG. 3c, which schematically illustrates a thermostat 300, essentially as disclosed in FIG. 3a, with a displaceable support-frame 310 and a closed aperture 356, wherein support-frame 310 is placed at a raised position relative to a default position 311, and a pin 332 being retracted, according to some embodiments. In this configuration, a distance is created between the distal end of pin 332 and support frame 310 at the raised position, such that an extension of pin 332 at an extent shorter than the initial distance between the distal end of pin 332 and support frame 310 may not result in a mechanical contra of the support frame to the extension of pin 332, therefore, thermal-actuator 330 and valve 336 are nor pushed downwardly to open aperture 356, contrary to what would have happened in common thermostat assemblies, when support frame 310 is positioned in the default position 331 as illustrated in FIG. 3a.

Reference is now made to FIG. 3d, which schematically illustrates a thermostat 300, essentially as disclosed in FIG. 3a, with a displaceable support-frame 310 and a closed aperture 356, with support-frame 310 placed at a raised position and a pin 332 being partially extended, according to some embodiments. In this configuration, the partial extension of pin 332 at an extent shorter-than/equal to the initial distance between the distal end of pin 332 and support frame 310 may not result in a mechanical contra of the support frame to the extension of pin 332, therefore, thermal-actuator 330 and valve 336 are nor pushed downwardly to open aperture 356.

When pin 332 is further extended, as the temperature is raised, the additional extension may result in having support frame 310 affect a mechanical contra to pin 332, pushing thermal-actuator 330 and associated valve apart from aperture 356 to open it.

Reference is now made to FIG. 3e, which schematically illustrates a thermostat 300, essentially as disclosed in FIG. 3a, with a displaceable support-frame 310 and an open aperture 356, with support-frame 310 placed at a raised position and a pin 332 being fully extended, according to some embodiments. According to some embodiments, the full extension of pin 332 may result in having support frame 310 affect a mechanical contra to pin 332, pushing thermal-actuator 330 and associated valve 336 apart from aperture 356, to open it and facilitate/permit flow of coolant fluids from source chamber 340 to drain chamber 342.

According to some embodiments, support frame 310 can be displaced to be lowered under the default/initial position thereof, thereby pressing against the distal end of pin 332, even without an extension of pin 332, thereby affecting a “forced-opening” of aperture 356 even without having the temperature reaching the threshold.

Reference is now made to FIG. 3f, which schematically illustrates a thermostat 300, essentially as disclosed in FIG. 3a, with a displaceable support-frame 310 and a forced-open aperture 356, with support-frame 310 placed at a lowered/dropped position, according to some embodiments. According to some embodiments, when an opening of aperture 356 is desired regardless of the actual temperature of fluids at drain chamber 342, support frame 310 may be lowered to press against pin 332 and push thermal-actuator 330 and mechanically-associated valve 336 apart from aperture 356, resulting in facilitation of fluid flow from source chamber 340 to drain chamber 342 even when the temperatures at drain chamber 342 have not reached temperatures that result in the extension of pin 332.

Advantageously, affecting a “forced-opening” of aperture 356 for allowing a flow of coolant fluids from the radiator to the engine may enable avoidance of over-heating of the engine, for example, on occasions when it is predicted/expected to have the engine temperature elevated.

According to some embodiments, the displacement of the support frame is controlled by the ECU (Engine-Control-Unit) of the vehicle. According to some embodiments, the displacement of the support frame is controlled by an associated control circuitry. According to some embodiments, the associated control circuitry may receive input signals indicative of the current temperature of the engine, number of engine revolutions per minute, throttle position, manifold pressure, velocity of the vehicle, and the like.

According to some embodiments, the displacement of the support frame may be actuated utilizing a linear actuation mechanism. According to some embodiments, the linear actuation mechanism may include a frame actuator comprising a pneumatic actuator, hydraulic actuator, electromechanical actuator, a mechanical actuator, or the like, or any combination thereof.

According to some embodiments, the mechanical actuator may include a leadscrew, screw jack, ball screw, hoist, rigid belt, rigid chain, rack-and-pinion, cam, or the like, or any combination thereof.

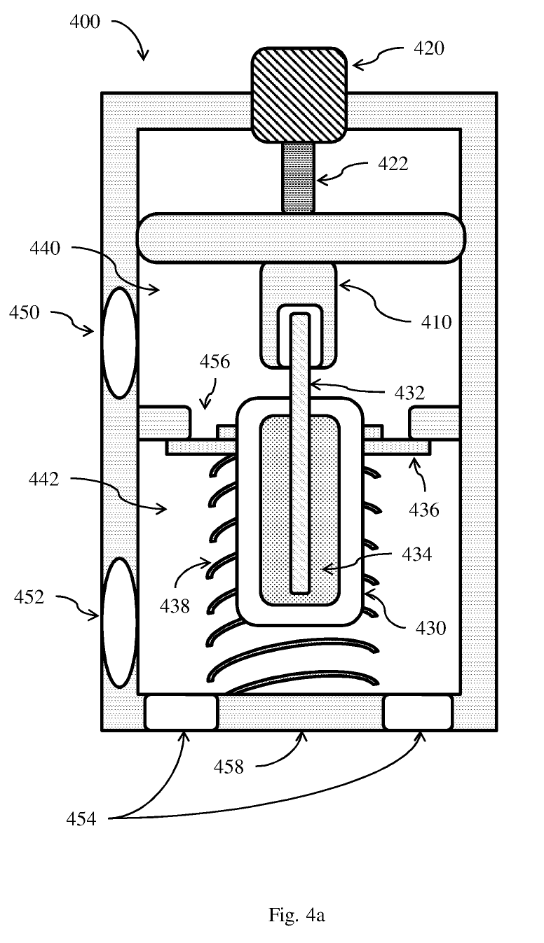

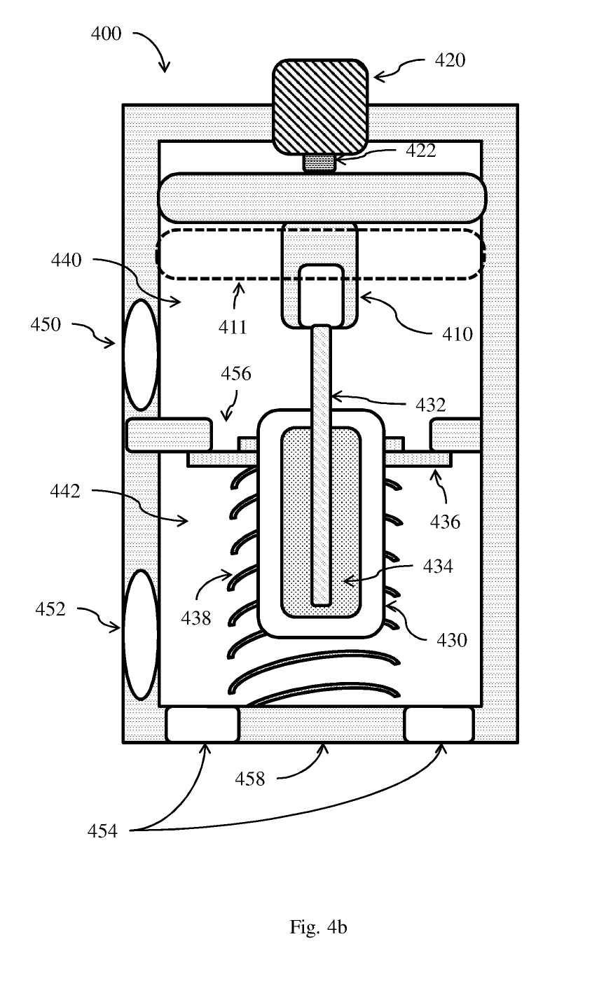

Reference is now made to FIG. 4a, which schematically illustrates a thermostat 400 with a displaceable support-frame 410 at a default/initial position and a linear frame actuator such as a screw-jack 420, according to some embodiments. According to some embodiments, screw-jack 420 includes an actuation screw 422 configured to affect a linear displacement of support frame 410.

Thermostat 400 is essentially as disclosed in FIG. 3 thermostat 300, including a displaceable support-frame 410 and a closed aperture 456, and support-frame 410 placed at a default/initial position, according to some embodiments. Thermostat 400 includes an engine-inlet orifice 454 configured to provide coolant fluids from the engine, an engine-outlet orifice 452 for providing coolant fluids from thermostat 400 to the engine, and a radiator-inlet orifice 450, configured to provide coolant fluids from a radiator to thermostat 400. Thermostat 400 further includes an internal aperture 456 defining a source chamber 440 which is configured to contain fluids from the radiator provided via radiator-inlet orifice 450, and a drain chamber 442, configured to contain fluids to be provided to the engine via engine-outlet orifice 452. Aperture 456 is opened and closed, to facilitate or obstruct flow of fluids therethrough respectively, by a valve 436 which is movable between a closed position in which valve 436 is introduced and pressed against aperture 456, and an open position in which valve 436 is furthered/distanced from aperture 456.

When aperture 456 is closed, flow of fluids from source chamber 440 and drain chamber 442 is obstructed, and the coolant fluids of the engine that are introduced via engine-inlet orifice 454 are circulated back to the engine through engine-outlet orifice 452. Alternatively, when aperture 456 is open, flow of fluids from source chamber 440 and drain chamber 442 is facilitated, and the coolant fluids that are provided to the engine through engine-outlet orifice 452 contain a mixture of fluids coming from the radiator via radiator-inlet orifice 450, and fluids coming from the engine via engine inlet orifice 454.

The movement of valve 436 is controlled by a thermal-actuator 430 having a reversibly extendible pin 432 partially immersed in a thermo-expandable material, such as wax 434. The thermal-actuator is at least partially placed in drain chamber 442, and is introduced to fluids from the engine, indicative of the engine temperature.

In operation, when the temperature at the drain chamber is below a certain threshold, wax 434 is contracted, and pin 432 is not pushed to extend outwardly. In this state, valve 436 and thermal-actuator 430 are pushed towards aperture 456 for closing it, for example, by a spring 438 which pushes against valve 436 at one end, and a lower support, such as lower-bridge 458.

When the temperature at the drain chamber reaches a predetermined threshold, wax 434 is expanded, and pin 432 is pushed out of wax 434 to extend upwardly, and support frame 410 provides a mechanical contra to the extension of pin 432, resulting in pushing thermal-actuator 430 and valve 436 downwardly and affecting an opening of aperture 456.

Reference is now made to FIG. 4b, which schematically illustrates a thermostat 400, essentially as disclosed in FIG. 4a, with a displaceable support-frame 410 at a raised position and a screw-jack 420, according to some embodiments. By instructing screw-jack 420 to raise an actuation screw 422, support frame 410 is raised above the default position 411, resulting in a lateral distance between the distal end of pin 432 and support frame 410. This distance results in that a partial extension of pin 432 does not push against support frame 410 for inducing a mechanical contra to affect an opening of aperture 456. And only an extension greater than a certain extent (dictated by the raising of support frame 410) may push against support frame 410 to initiate an opening of aperture 456.

Reference is now made to FIG. 4c, which schematically illustrates a thermostat 400, essentially as disclosed in FIG. 4a, with a displaceable support-frame 410 at a lowered/dropped position relative to the default position 411 and a screw-jack 420 with an actuation screw 422, according to some embodiments. When screw-jack 420 is operated for extending actuation screw 422, support frame 410 is lowered/dropped below default position 411, thereby pushing against pin 432 and forcing down thermal-actuator 430 and valve 436 to open aperture 456 and facilitate flow of fluids from source chamber 440 to drain chamber 442.

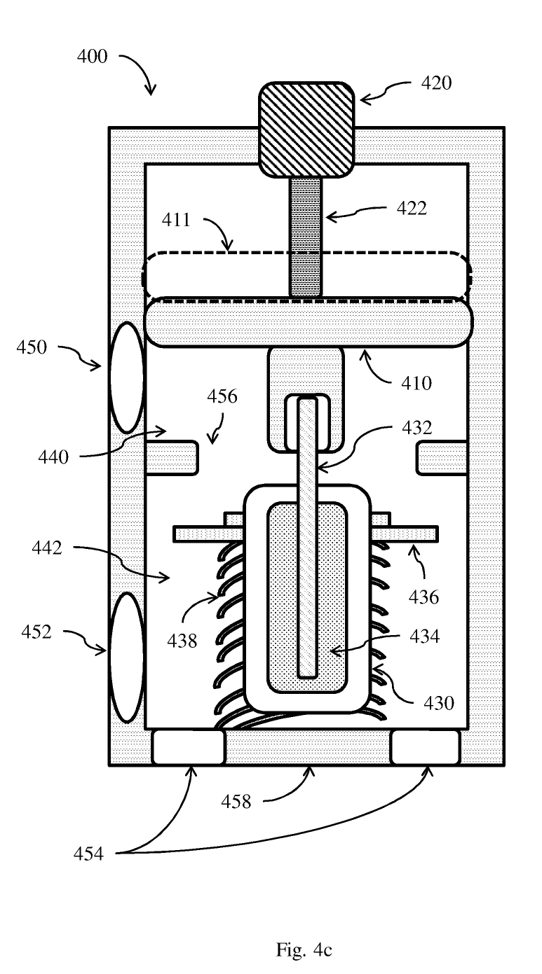

Reference is now made to FIG. 5, which schematically illustrates a thermostat 500, essentially as disclosed in FIG. 3a Thermostat 300, with a displaceable support-frame 510 at a default/initial position and a hydraulic actuator 520, according to some embodiments. According to some embodiments, hydraulic actuator 520 is configured to induce a displacement of support frame 510 by introducing pressurized fluids or gasses to pressure chamber 524 via hydraulic port 522.

According to some embodiments, only part(s) of the support frame are displaceable, for example, a contra head/tip of the support frame may be displaceable relative to the aperture.

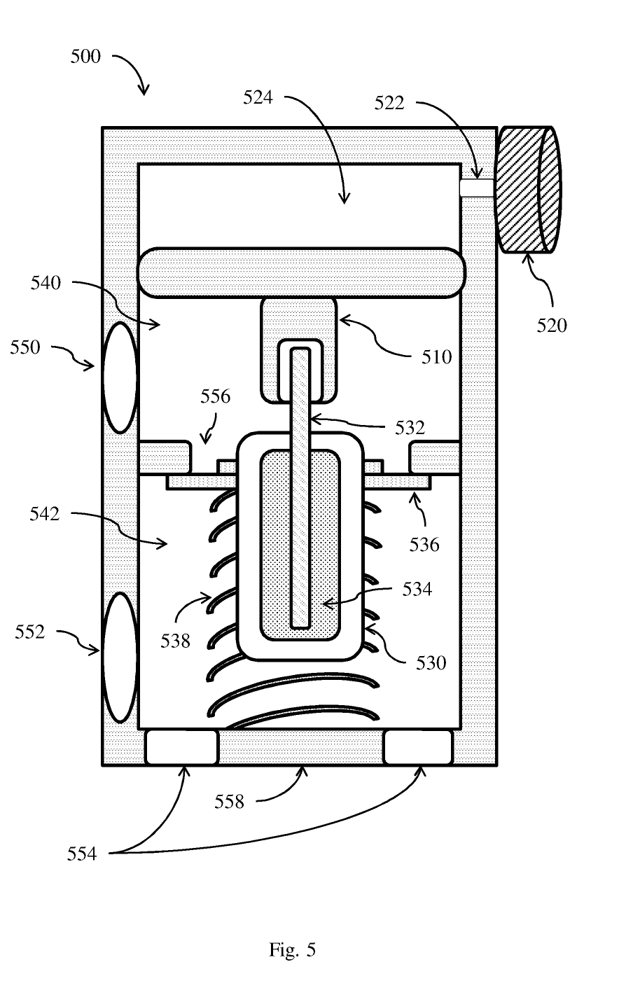

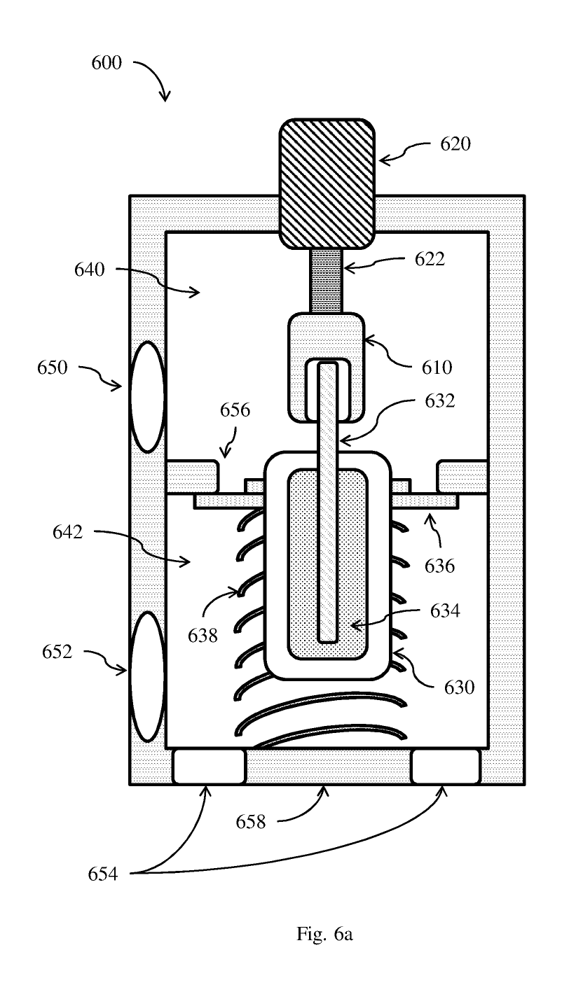

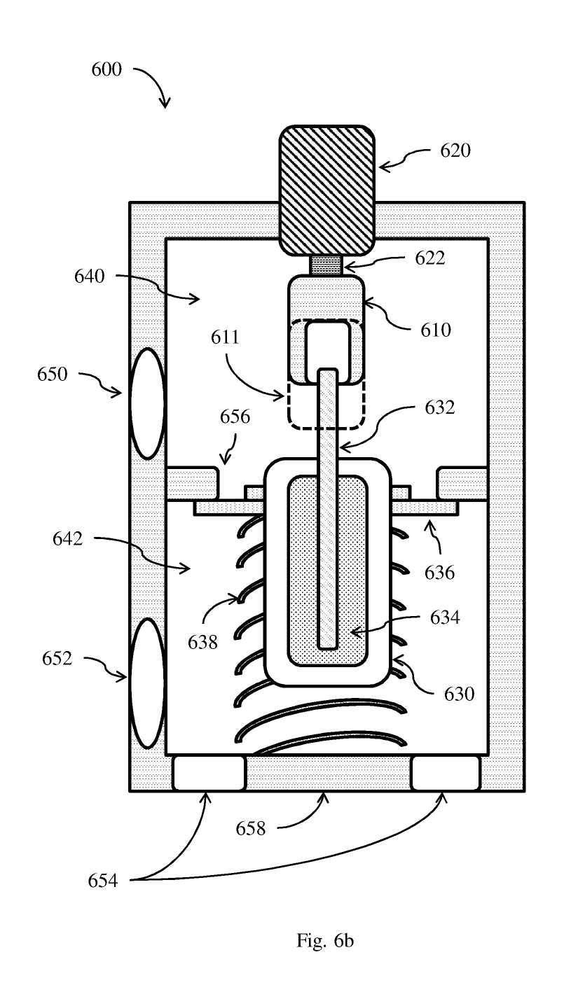

Reference is now made to FIG. 6a, which schematically illustrates a thermostat 600 with a displaceable support-frame tip 610 at a default/initial position and a linear frame actuator such as screw-jack 620, according to some embodiments. According to some embodiments, screw-jack 620 includes an actuation screw 622 configured to affect a linear displacement of support-frame tip 610.

Thermostat 600 is essentially as disclosed in FIG. 4 thermostat 400, including a displaceable support-frame tip 610 and a closed aperture 656, and support-frame tip 610 placed at a default/initial position, according to some embodiments. Thermostat 600 includes an engine-inlet orifice 654 configured to provide coolant fluids from the engine, an engine-outlet orifice 652 for providing coolant fluids from thermostat 600 to the engine, and a radiator-inlet orifice 650, configured to provide coolant fluids from a radiator to thermostat 600. Thermostat 600 further includes internal aperture 656, defining a source chamber 640 which is configured to contain fluids from the radiator provided via radiator-inlet orifice 650, and a drain chamber 642, configured to contain fluids to be provided to the engine via engine-outlet orifice 652. Aperture 656 is opened and closed, to facilitate or obstruct flow of fluids therethrough respectively, by a valve 636 which is movable between a closed position in which valve 636 is introduced and pressed against aperture 656, and an open position in which valve 636 is separated/distanced from aperture 656.

When aperture 656 is closed, flow of fluids from source chamber 640 and drain chamber 642 is obstructed, and the coolant fluids of the engine that are introduced via engine-inlet orifice 654 are circulated back to the engine through engine-outlet orifice 652. Alternatively, when aperture 656 is open, flow of fluids from source chamber 640 and drain chamber 642 is facilitated, and the coolant fluids that are provided to the engine through engine-outlet orifice 652 contain a mixture of fluids coming from the radiator via radiator-inlet orifice 650, and fluids coming from the engine via engine inlet orifice 654.

The movement of valve 636 is controlled by a thermal-actuator 630 having a reversibly extendible pin 632 partially immersed in a thermo-expandable material, such as wax 634. Thermal-actuator 630 is at least partially placed in drain chamber 642, and is introduced to fluids from engine, indicative of the engine temperature.

In operation, when the temperature at the drain chamber is below a certain threshold, wax 634 is contracted, and pin 632 is not pushed to extend outwardly. In this state, valve 636 and thermal-actuator 630 are pushed towards aperture 656 for closing it, for example by a spring 638 which pushes against valve 636 at one end, and a lower support, such as lower-bridge 658.

When the temperature at the drain chamber reaches a predetermined threshold, wax 634 is expanded, and pin 632 is pushed out of wax 634 to extend upwardly, and support-frame tip 610 provides a mechanical contra to the extension of pin 632, resulting in pushing thermal-actuator 630 and valve 636 downwardly and affecting an opening of aperture 656.

Reference is now made to FIG. 6b, which schematically illustrates a thermostat 600, essentially as disclosed in FIG. 6a, with a displaceable support-frame tip 610 at a raised position and a screw-jack 620, according to some embodiments. By instructing screw-jack 620 to raise an actuation screw 622, support-frame tip 610 is raised above the default position 611, resulting in a lateral distance between the distal end of a pin 632 and support-frame tip 610. This distance results in that a partial extension of pin 632 does not push against support-frame tip 610 for inducing a mechanical contra to affect an opening of an aperture 656. And only an extension greater than a certain extent (dictated by the raising of support-frame tip 610) may push against support-frame tip 610 to initiate an opening of aperture 656.

Reference is now made to FIG. 6c, which schematically illustrates a thermostat 600, essentially as disclosed in FIG. 6a, with a displaceable support-frame tip 610 at a lowered/dropped position relative to the default position 611 and a screw-jack 620 with an actuation screw 622, according to some embodiments. When screw-jack 620 is operated for extending actuation screw 622, support-frame tip 610 is lowered/dropped below default position 611, thereby pushing against a pin 632 and forcing down thermal-actuator 630 and valve 636 to open an aperture 656 and facilitate flow of fluids from a source chamber 640 to a drain chamber 642.

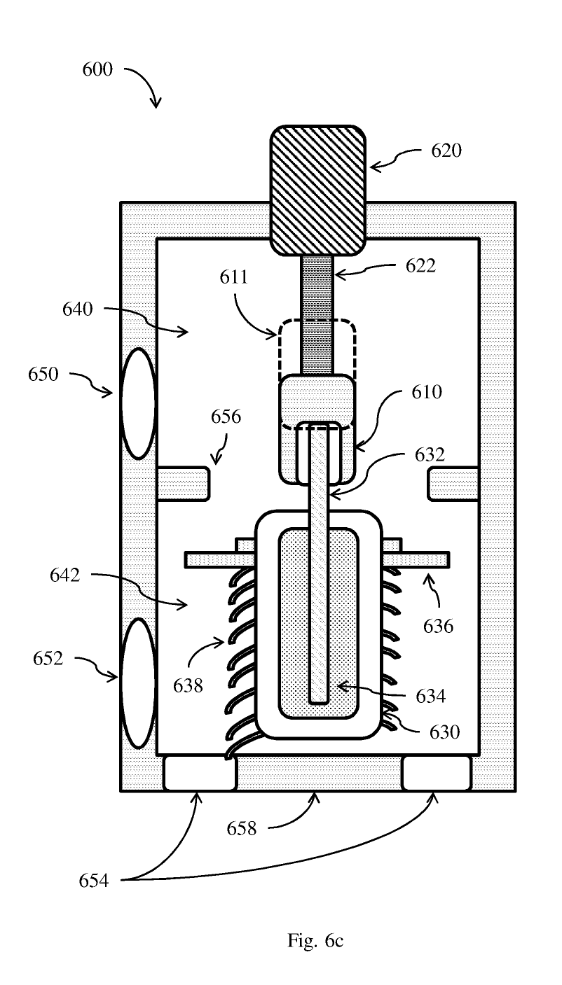

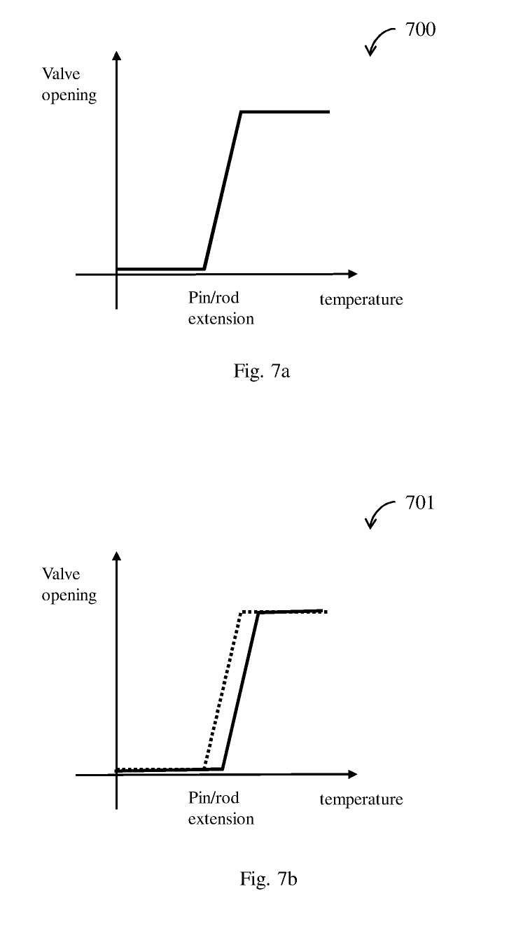

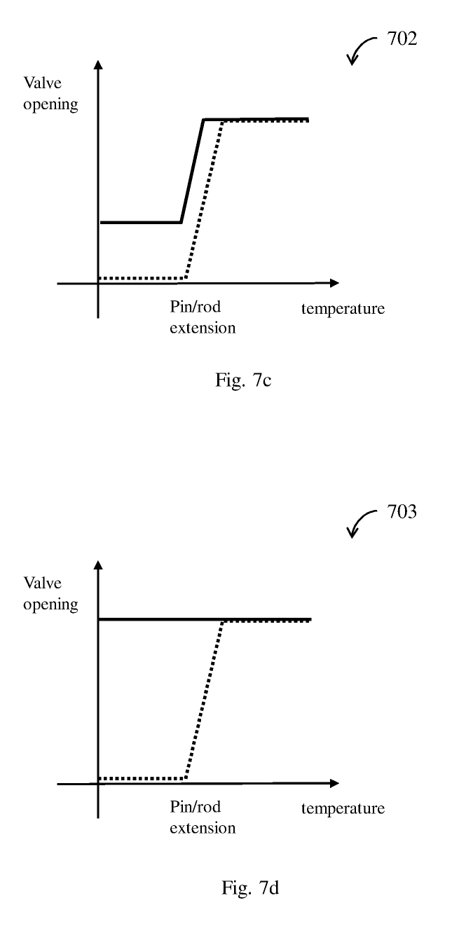

Reference is now made to FIG. 7a, which schematically illustrates a thermostat temperature response graph 700, with a displaceable support frame at a default position, according to some embodiments. At this position, the relationship between the temperature of the engine coolant fluids (resulting in an extension of the pin) and the opening of the thermostat aperture is similar to a regular thermostat, in that upon extension of the pin, it is pressed against the support frame and initiates a valve movement for an aperture opening.

Reference is now made to FIG. 7b, which schematically illustrates a thermostat temperature response graph 701, with a displaceable support frame at a raised position, according to some embodiments. At this position, the relationship between the temperature of the engine coolant fluids (resulting in an extension of the pin) and the opening of the thermostat aperture is skewed up relative to the operation in default position, and the temperature at which the valve is opened is higher than at the default position of the support frame. A greater extent of pin extension (higher temperature) is required for the pin to be introduced to the support frame, such that only at higher temperatures does the aperture opens for facilitating a flow of radiator coolant fluid to the engine, resulting in an elevated operation temperature of the engine.

Reference is now made to FIG. 7c, which schematically illustrates a thermostat temperature response graph 702, with a displaceable support frame at a partially lowered position, according to some embodiments. At this position, the relationship between the temperature of the engine coolant fluids (resulting in an extension of the pin) and the opening of the thermostat aperture is skewed down relative to the operation in default position, and a partial opening of the aperture occurs even without an extension of the pin, thereby allowing partial flow of fluid regardless to temperature of the engine fluids; and when the temperatures are elevated and the pin is extended, the aperture is fully opened.

Reference is now made to FIG. 7d, which schematically illustrates a thermostat temperature response graph 703, with a displaceable support frame at a fully lowered position, according to some embodiments. At this position, the aperture is forced open by the support frame pushing downwardly against it, without being affected by the temperature of the engine coolant fluids (and extension of the pin)

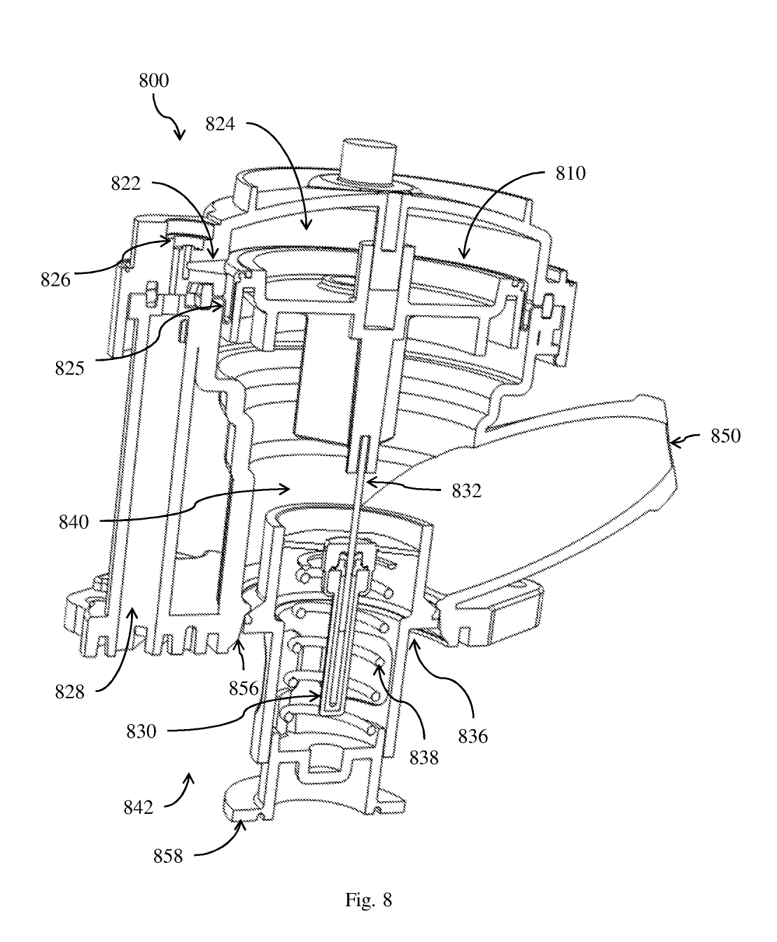

Reference is now made to FIG. 8, which schematically illustrates a cross section thermostat 800 at a perspective front view, according to some embodiments. According to some embodiments, thermostat 800 includes an aperture 856 separating between a source region 840 (receiving radiator coolant fluids via a radiator-inlet orifice 850), and a drain region 842 fluidly connected with an engine to provide and receive coolant fluids therefrom and thereto. Thermostat 800 further includes a valve 836 connected mechanically to a thermal-actuator 830 having an extendible pin 832 extended therefrom, valve 836 is normally pushed against aperture 856 to close it by a spring 838 supported by a lower bridge/base 858. Upon elevation of temperatures at drain region 842, pin 832 is extended upwardly, and is pressed against support frame 810, which provides a mechanical contra to the pin, resulting in pushing thermal-actuator 830 and valve 836 away from aperture 856, affecting an opening of aperture 856.

Support frame 810 is displaceable linearly by a hydraulic mechanism (not shown) providing pressurized flow of fluids or gasses to pressure chamber 824 via hydraulic port 822 to push support frame 810 up or down, placing it at a desired position. According to some embodiments, thermostat 800 further includes a hydraulic channel 828 configured to be connected to a hydraulic pump (not shown), fluidly connected with hydraulic port 822 through a hydraulic valve, such as solenoid valve 826 for controllably allowing and blocking the flow of pressurized fluids from hydraulic channel 828 to hydraulic actuation channel 824. According to some embodiments, thermostat 800 further includes a diaphragm 825 connected between support-frame 810 and inner surface/walls of source chamber 840, configured to provide a sealed separation between hydraulic actuation chamber 824 and source chamber 840.

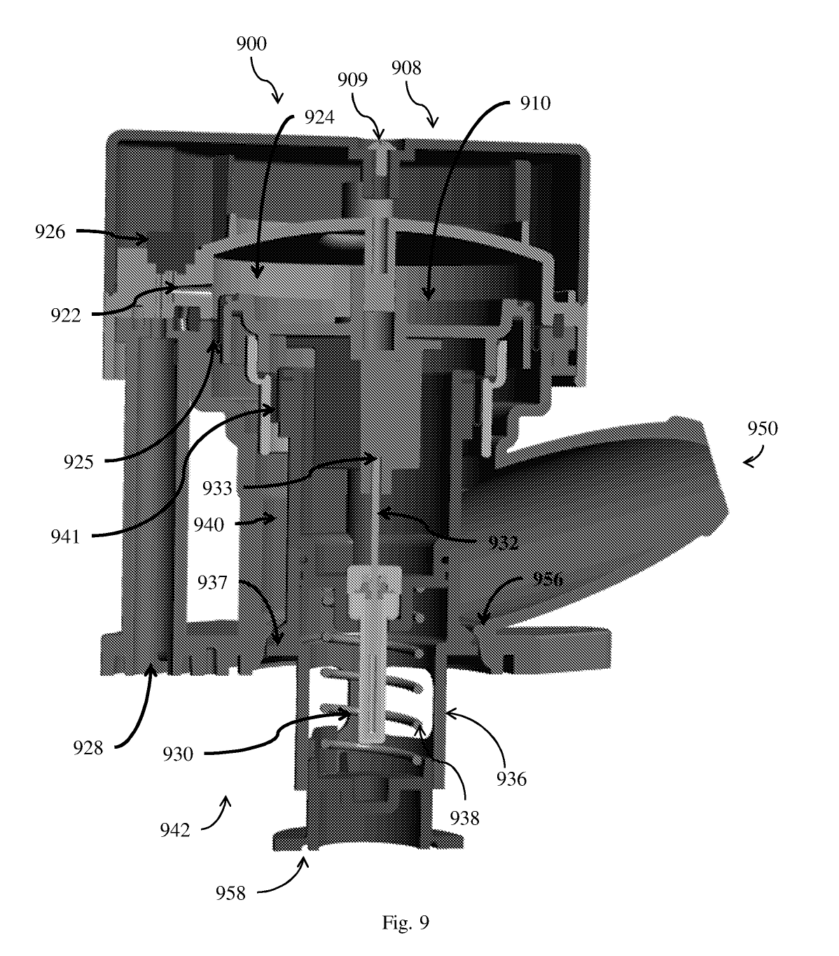

Reference is now made to FIG. 9, which schematically illustrates a cross section of a thermostat 900 assembly/housing at a front view, according to some embodiments. According to some embodiments, thermostat 900 includes a source chamber 940 configured/designed to contain coolant fluids provided from a radiator, a radiator-inlet orifice 950, configured to be fluidly connected with a radiator and provide coolant fluids from the radiator to source chamber 940, and a drain chamber 942 configured to contain coolant fluids to be provided to an engine. Drain chamber 942 is designed to have an engine-inlet orifice (not shown), configured to be fluidly connected with an engine and provide coolant fluids from the engine to the drain chamber, and an engine-outlet orifice (not shown), configured to be fluidly connected with the engine and provide coolant fluids from the drain chamber to the engine.

According to some embodiments, thermostat 900 includes a valve 936, with a valve seal 937, movable for affecting opening and closing of an internal aperture 956 between source region 940 and drain region 942, thereby facilitating and blocking a flow of fluid from source region 940 to drain region 942. Valve 936 is mechanically connected to a thermal-actuator 930, which includes a reversibly extendible pin 932 with a distal end 933 at the extremis thereof, configured to be extended and retracted based on temperature of thermal-actuator 930. Thermal-actuator 930 and associated valve 936 are normally pushed against aperture 956, to close it, by a spring 938 anchored/supported by a lower-bridge 958. Upon extension of pin 932, it is pressed against a support frame 910 which provides a mechanical contra thereto, and pushes thermal-actuator 930 and valve 936 towards lower-bridge 958 to affect an opening of aperture 956 facilitating a flow of fluids from source chamber 940 to drain chamber 942.

According to some embodiments, support frame 910 is linearly displaceable and located adjacent to distal end 933 of pin 932, and configured to provide a mechanical contra to the extension of pin 932. According to some embodiments, the linear displacement of support frame 910 is actuated hydraulically by pressurized fluids provided to a hydraulic actuation chamber 924 via a hydraulic port 922. According to some embodiments, thermostat 900 further includes a hydraulic channel 928 configured to be connected to a hydraulic pump (not shown), fluidly connected with hydraulic port 922 through a hydraulic valve, such as solenoid valve 926 for controllably allowing and blocking the flow of pressurized fluids from hydraulic channel 928 to hydraulic actuation channel 924. According to some embodiments, thermostat 900 further includes a diaphragm 925 connected between support-frame 910 and inner surface/walls of source chamber 940, configured to provide a sealed separation between hydraulic actuation chamber 924 and source chamber 940. Additionally, according to some embodiments, there is also a valve-diaphragm 941, connected between valve 936 and support-frame 910 allowing relative movement therebetween.

According to some embodiments, thermostat 900 further includes a cover 908 mechanically connected to hydraulic actuation channel 924 using a fastener 909.

According to some embodiments, there is provided a thermostat, configured for controlling a flow of fluid, the thermostat including an aperture between a source region and a drain region in the thermostat, a valve, movable for affecting opening and closing of the aperture, thereby facilitating and blocking a flow of fluid from the source region to the drain region, a thermal-actuator, mechanically connected with the valve, including a reversibly extendible pin configured to be extended and retracted based on temperature of the thermal-actuator, and a support-frame, located adjacent to a distal end of the pin, and configured to provide a mechanical contra to the extension of the pin, such that, upon extension of the pin, the thermal-actuator and valve are pushed/distanced/parted from the aperture, facilitating a flow of fluid from the source region to the drain region, wherein the support frame is linearly displaceable relative to the aperture for modifying operational characteristics of the opening and closing of the aperture by the valve.

According to some embodiments, the thermostat further includes a frame-actuator configured to affect a linear displacement of the support-frame. According to some embodiments, the frame-actuator comprises a pneumatic actuator. According to some embodiments, the frame-actuator comprises a hydraulic actuator. According to some embodiments, the frame-actuator comprises an electromechanical actuator. According to some embodiments, the frame-actuator comprises a mechanical actuator selected from a list consisting of: a leadscrew, screw jack, ball screw, hoist, rigid belt, rigid chain, rack-and-pinion, and cam. According to some embodiments, the support-frame is linearly displaceable relative to the aperture for pressing against the pin and affecting a movement of the pin, the thermal-actuator and the valve apart from the valve, thereby facilitating a non-thermal opening of the aperture.

According to some embodiments the support-frame is linearly displaceable relative to the aperture to control/regulate the amount of extension of the pin required for affecting an opening of the valve. According to some embodiments, the support frame is linearly displaceable between at least a baseline-position and a high-position, such that in the baseline position the support frame is approximated to the aperture for providing mechanical contra to the extension of the pin from an early stage thereof, and in the high-position the support frame is furthered from the aperture for providing mechanical contra to the extension of the pin from a later stage thereof.

According to some embodiments, there is provided a thermostat housing, configured for controlling a flow of fluid, including a radiator-inlet orifice, configured to be fluidly connected with a radiator and provide coolant fluids from the radiator to the thermostat housing, an engine-inlet orifice, configured to be fluidly connected with an engine and provide coolant fluids from the engine to the thermostat housing, an engine-outlet orifice, configured to be fluidly connected with the engine and provide coolant fluids from the thermostat housing to the engine, an aperture separating between /defining a source region and a drain region in the thermostat, the source region comprising the radiator-inlet orifice and the drain region comprising the engine-inlet orifice and the engine-outlet orifice, a valve, movable for affecting and opening and closing of said aperture, thereby facilitating and blocking/obstructing a flow of fluid from said source region to said drain region, a thermal-actuator, mechanically connected with said valve, including a reversibly extendible pin configured to be extended and retracted based on temperature of the thermal-actuator, and a support-frame, located adjacent-to a distal end of said pin, and configured to provide a mechanical contra to the extension of the pin, such that, upon extension of the pin, said thermal-actuator and valve are pushed/distanced/parted from the aperture, facilitating a flow of fluid from the source region to the drain region, wherein the support frame is linearly displaceable relative to the aperture for modifying operational characteristics of the opening and closing of the aperture by the valve.

According to some embodiments, the thermostat housing further comprises a frame-actuation inlet, configured to provide and removing pressurized fluids/gasses to a chamber confined by the housing and the support-frame for affecting a displacement of the support frame. According to some embodiments, the thermostat housing further includes a hydraulic pump, fluidly connected with the frame-actuation inlet.

According to some embodiments, the thermostat housing includes a frame-actuator configured to affect a linear displacement of the support-frame. According to some embodiments, the frame-actuator comprises a pneumatic actuator. According to some embodiments, the frame-actuator comprises a hydraulic actuator. According to some embodiments, the frame-actuator comprises an electromechanical actuator. According to some embodiments, the frame-actuator comprises a mechanical actuator selected from a list consisting of: a leadscrew, screw jack, ball screw, hoist, rigid belt, rigid chain, rack-and-pinion, and cam. According to some embodiments, the support-frame is linearly displaceable relative to the aperture for pressing against the pin and affecting a movement of the pin, the thermal-actuator and the valve apart from the valve, thereby facilitating a non-thermal opening of the aperture.

According to some embodiments, the support-frame is linearly displaceable relative to the aperture to control/regulate the amount of extension of the pin required for affecting an opening of the valve. According to some embodiments, the support frame is linearly displaceable between at least a baseline-position and a high-position, such that in the baseline position the support frame is approximated to the aperture for providing mechanical contra to the extension of the pin from an early stage thereof, and in the high-position the support frame is furthered from the aperture for providing mechanical contra to the extension of the pin from a later stage thereof.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

What is claimed is:

1. A thermostat, configured for controlling a flow of fluid, comprising:
a source chamber, configured to contain coolant fluids provided from a radiator;
a drain chamber, configured to contain coolant fluids to be provided to an engine;
a valve, movable for affecting opening and closing of an aperture between said source chamber and said drain chamber, thereby facilitating and blocking a flow of fluid from said source chamber to said drain chamber;
a thermal-actuator, mechanically connected to said valve, including a reversibly extendible pin with a distal end at the extremis thereof, configured to be extended and retracted based on temperature of the thermal-actuator;
a linearly displaceable support-frame, located adjacent to said distal end of said pin, and configured to provide a mechanical contra to the extension of the pin, such that, upon extension of the pin, said thermal-actuator and valve are pushed/distanced/parted from said aperture, facilitating a flow of fluid from said source chamber to said drain chamber; and
a hydraulic actuation chamber with a hydraulic-port, configured to be connected to a hydraulic pump to be provided with pressurized fluids via said hydraulic-port, for actuating a linear displacement of said support frame relative to said aperture for modifying operational characteristics of the opening and closing of the aperture by said valve.

2. The thermostat of claim 1, further comprising a diaphragm, connected between said support-frame and inner surface/walls of said source chamber, configured to provide a sealed separation between said hydraulic actuation chamber and said source chamber.

3. The thermostat of claim 1, wherein said support-frame is linearly displaceable within a range of 0.1 mm to 15 mm from a default position.

4. The thermostat of claim 1, further comprising a hydraulic valve, configured to controllably open and close said hydraulic port.

5. The thermostat of claim 4, wherein said hydraulic valve comprises a solenoid valve operator.

6. The thermostat of claim 1, wherein said support-frame is linearly displaceable relative to said aperture for pressing against said pin and affecting a movement of said pin, said thermal-actuator and said valve apart from said valve, thereby facilitating a forced opening of the aperture.

7. The thermostat of claim 1, wherein said support-frame is linearly displaceable relative to said aperture to control/regulate the amount of extension of the pin required for affecting an opening of said valve.

8. The thermostat of claim 7, wherein said support frame is linearly displaceable between at least a baseline-position and a high-position, such that in the baseline position said support frame is approximated to said aperture for providing mechanical contra to the extension of said pin from an early stage thereof, and in the high-position said support frame is distanced from said aperture for providing mechanical contra to the extension of the pin from a later stage thereof.

9. A thermostat housing, configured for controlling a flow of fluid, comprising:
a source chamber, configured to contain coolant fluids provided from a radiator;
a radiator-inlet orifice, configured to be fluidly connected with a radiator and provide coolant fluids from the radiator to said source chamber;
a drain chamber, configured to contain coolant fluids to be provided to an engine;
an engine-inlet orifice, configured to be fluidly connected with an engine and provide coolant fluids from the engine to said drain chamber;
an engine-outlet orifice, configured to be fluidly connected with the engine and provide coolant fluids from said drain chamber to the engine;
a valve, movable for affecting opening and closing of an aperture between said source chamber and said drain chamber, thereby facilitating and blocking a flow of fluid from said source chamber to said drain chamber;
a thermal-actuator, mechanically connected with said valve, including a reversibly extendible pin with a distal end at the extremis thereof, configured to be extended and retracted based on temperature of the thermal-actuator;
a linearly displaceable support-frame, located adjacent to said distal end of said pin, and configured to provide a mechanical contra to the extension of the pin, such that, upon extension of the pin, said thermal-actuator and valve are pushed/distanced/parted from said aperture, facilitating a flow of fluid from said source chamber to said drain chamber; and
a hydraulic actuation chamber with a hydraulic-port, configured to be connected to a hydraulic pump to be provided with pressurized fluids via said hydraulic-port, for actuating a linear displacement of said support frame relative to said aperture for modifying operational characteristics of the opening and closing of the aperture by said valve.

10. The thermostat housing of claim 9, further comprising a diaphragm, connected between said support-frame and inner surface/walls of said source chamber, configured to provide a sealed separation between said hydraulic actuation chamber and said source chamber.

11. The thermostat housing of claim 9, wherein said support-frame is linearly displaceable within a range of 0.1 mm to 15 mm from a default position.

12. The thermostat housing of claim 9, further comprising a hydraulic valve, configured to controllably open and close said hydraulic port.

13. The thermostat of claim 12, wherein said hydraulic valve comprises a solenoid valve operator.

14. The thermostat housing of claim 12, further comprising a hydraulic channel, fluidly connected to said hydraulic valve and configured to be connected to a hydraulic pump, for providing pressurized fluids to said hydraulic valve, wherein the hydraulic valve is configured to controllably allow or block the flow of pressurized fluids between said hydraulic actuation chamber and said hydraulic channel via said hydraulic port.

15. The thermostat housing of claim 9, wherein said support-frame is linearly displaceable relative to said aperture for pressing against said pin and affecting a movement of said pin, said thermal-actuator and said valve apart from said valve, thereby facilitating a forced opening of the aperture.

16. The thermostat housing of claim 9, wherein said support-frame is linearly displaceable relative to said aperture to control/regulate the amount of extension of the pin required for affecting an opening of said valve.

17. The thermostat housing of claim 16, wherein said support frame is linearly displaceable between at least a baseline-position and a high-position, such that in the baseline position said support frame is approximated to said aperture for providing mechanical contra to the extension of said pin from an early stage thereof, and in the high-position said support frame is distanced from said aperture for providing mechanical contra to the extension of the pin from a later stage thereof.
